(19) United States
(12) Patent Application Publication
(10) Pub. No.: US 2015/0248699 A1
(43) Pub. Date: Sep. 3, 2015

(54) KEYWORD REMARKETING

(71) Applicant: Google Inc., (US)

(72) Inventors: David Hammer, New York, NY (US); Neal Mohan, Mountain View, CA (US); Jason C. Miller, Mountain View, CA (US)

(21) Appl. No.: 13/689,914

(22) Filed: Nov. 30, 2012

(51) Int. Cl. G06Q 30/02

(52) U.S. Cl. CPC G06Q 30/0256

(57) ABSTRACT

Methods, systems, and apparatus for keyword remarketing. In one aspect, a method includes generating a keyword remarketing list associated with one or more keywords selected by a content item provider; adding a recipient identifier to the keyword remarketing list in response to receiving an indication that a user device has interacted with a search content item, the search content item having been provided to the user device in response to the user device transmitting a search query; receiving a content item request for a content item to be provided; determining that the content item request is for a user device that is associated with a recipient identifier included in the keyword remarketing list; and providing a remarketing content item to the user device, the remarketing content item being a content item provided by the content item provider for distribution to user devices included in the keyword remarketing list.

### BACKGROUND

This specification relates to keyword remarketing.

The Internet provides access to a wide variety of resources, for example, webpages, images, audio files, and videos. Such access to these resources has likewise enabled opportunities for providing relevant additional content. One example of additional content is advertisements. For example, resources of particular interest to a user can be identified by a search engine in response to a user query. By comparing the user query to a list of keywords specified by an advertiser, it is possible to provide relevant advertisements (or other content items) to the user with search results.

Another form of online advertising is remarketing, which allows advertisers to choose particular advertisements to be shown to users who have performed certain actions on a web page of an advertiser. For example, an advertiser can choose to show a particular advertisement to users who have recently visited the advertiser's website. As these users are likely interested in the advertiser's offerings, they are likely to be interested in the advertised product or service. Accordingly, remarketing can help drive online customers to the advertiser's website.

### SUMMARY

This specification describes technologies relating to keyword remarketing.

In general, one innovative aspect of the subject matter described in this specification can be embodied in methods that include the actions of generating a keyword remarketing list associated with one or more keywords selected by a content item provider; for each of a plurality of recipient identifiers, adding the recipient identifier to the keyword remarketing list in response to receiving an indication that a user device that corresponds to the recipient identifier has interacted with a search content item of the content item provider, the search content item having been provided to the user device in response to the user device transmitting a search query associated with one of the keywords; receiving a content item request for a content item to be provided with a publisher resource; determining that the content item request for the content item is for a user device that is associated with a recipient identifier included in the keyword remarketing list; and in response to the determination, providing a remarketing content item associated with the keyword remarketing list to the user device, the remarketing content item being a content item provided by the content item provider for distribution to user devices associated with recipient identifiers included in the keyword remarketing list. Other embodiments of this aspect include corresponding systems, apparatus, and computer programs, configured to perform the actions of the methods, encoded on computer storage devices.

These and other embodiments can each optionally include one or more of the following features.

Receiving a content item request may comprise receiving a content item request from the user device that is associated with a recipient identifier included in the keyword remarketing list.

Receiving a content item request may comprise receiving a content item request from a content item network, and the content item request may include data indicating that the content item request is for a user device that is associated with a recipient identifier included in the keyword remarketing list.

The publisher resource may be a web page hosted by a publisher, and the content item request may be generated in response to the user device rendering the publisher resource.

The interaction with the search content item may comprise a selection of the search content item at the user device.

The recipient identifier may be stored in a cookie associated with a content item server, and the cookie may be provided to the user device in response to the selection.

Particular embodiments of the subject matter described in this specification can be implemented so as to realize one or more of the following advantages. Content item providers, such as advertisers, are presented with additional opportunities to customize content items for particular users without the need to specify particular content items or particular landing pages subject to remarketing. Instead, remarketing opportunities are identified on a keyword basis in conjunction with a user interaction. This allows content item providers to facilitate the generation of remarketing lists based on keywords without requiring modification of content item providers' landing pages, and without requiring referral information to be provided to or interpreted by content item providers. In addition, neither the content items nor the landing pages of the content item providers need be identified in advance. Remarketing helps advertisers identify opportunities to advertise to users who have already expressed an interest in products or services the advertisers offer. This may lead to a better return on investment for advertisers. Users, in turn, are provided with advertisements and other content items that are likely to be of interest the user.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram of an example environment in which keyword remarketing occurs.

FIG. 1B is a block diagram of an example data flow that represents a keyword remarketing process.

FIG. 2 is a flow diagram of an example process for performing keyword remarketing.

FIG. 3 is a block diagram of an example data processing apparatus.

Like reference numbers and designations in the various drawings indicate like elements.

### DETAILED DESCRIPTION

Advertisers may run advertising campaigns designed to provide customized or particular advertisements to users who have expressed interest in the advertiser's products or services. The systems and methods described below provide remarketing advertisements to users based on the users' interactions with search-based advertisements.

An advertiser may select keywords to associate with a keyword remarketing list. The keywords to associate with an advertiser's keyword remarketing list may be selected from keywords that the advertiser is using to distribute search advertisements through a search engine. For example, a shoe company may have a keyword remarketing list associated with the keyword, “shoes,” and a search advertisement associated with the keyword, “shoes.” The search advertisement is an advertisement that may be presented to a user device in response to the user device transmitting a search query that includes the word, “shoes,” to the search engine.

User devices have recipient identifiers that may be added to an advertiser's keyword remarketing list in response to a user device interacting with a search advertisement of the advertiser. For example, if a user device transmits a search query including the word “shoes” to a search engine, the user device may be presented with the search advertisement associated with the keyword, “shoes.” If a user of the user device clicks on the search advertisement, a recipient identifier associated with the user device in the form of a advertisement server cookie (or some other identifier) may be set on the user device. Furthermore, the cookie identifier may be added to the advertiser's keyword remarketing list that is associated with the keyword, “shoes.”

At a later time, an advertisement system may receive a request for an advertisement to be provided with a publisher's resource, such as a web page. If the request indicates that the advertisement request is for a user device having a recipient identifier that is included in the keyword remarketing list, a remarketing advertisement associated with the keyword remarketing list may then be provided to the user device.

These features and other features are described in more detail below.

For situations in which the systems discussed here collect information about users, or may make use of information about users, the users may be provided with an opportunity to control whether programs or features that may collect user information (e.g., information about a user's social network, social actions or activities, a user's preferences, or a user's current location), or to control whether and/or how to receive content from the content server that may be more relevant to the user. In addition, certain data may be treated in one or more ways before it is stored or used, so that certain information about the user is removed when generating parameters (e.g., demographic parameters). For example, a user's identity may be treated so that no identifying information can be determined for the user, or a user's geographic location may be generalized where location information is obtained (such as to a city, ZIP code, or state level), so that a particular location of a user cannot be determined. Thus, users may have control over how information is collected about them and used by a content server.

While implementations below are described with reference to advertisers and advertisements, the description is equally applicable to all content item providers and content items. The systems and methods described herein need not be limited to advertisers and advertisements.

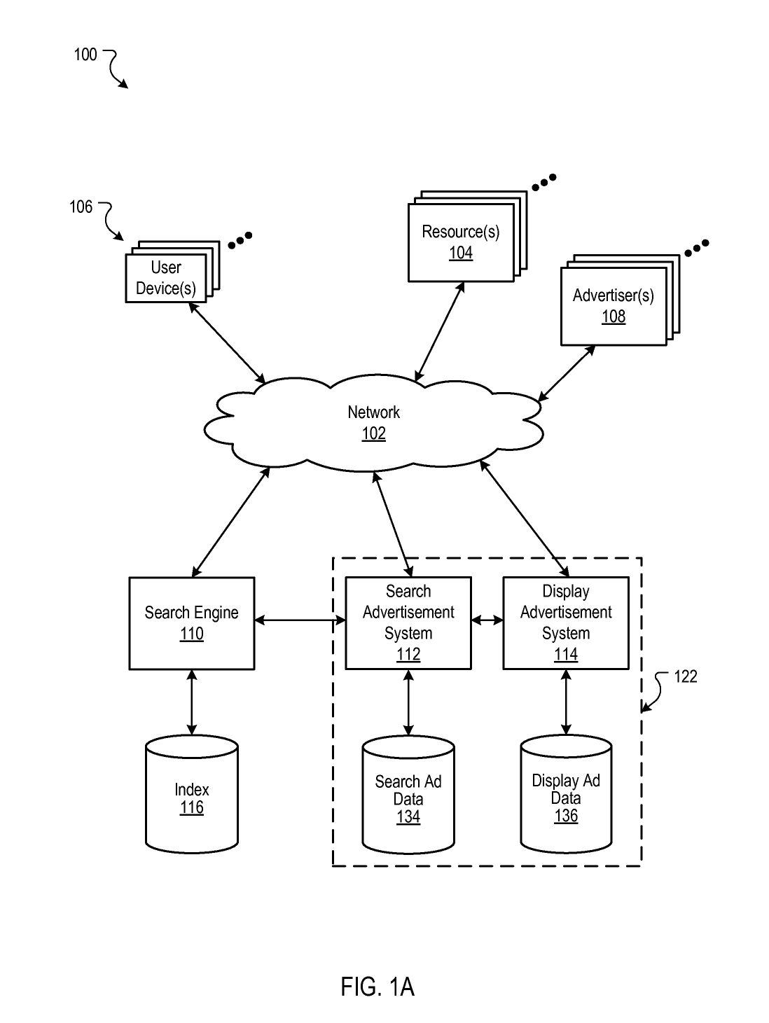

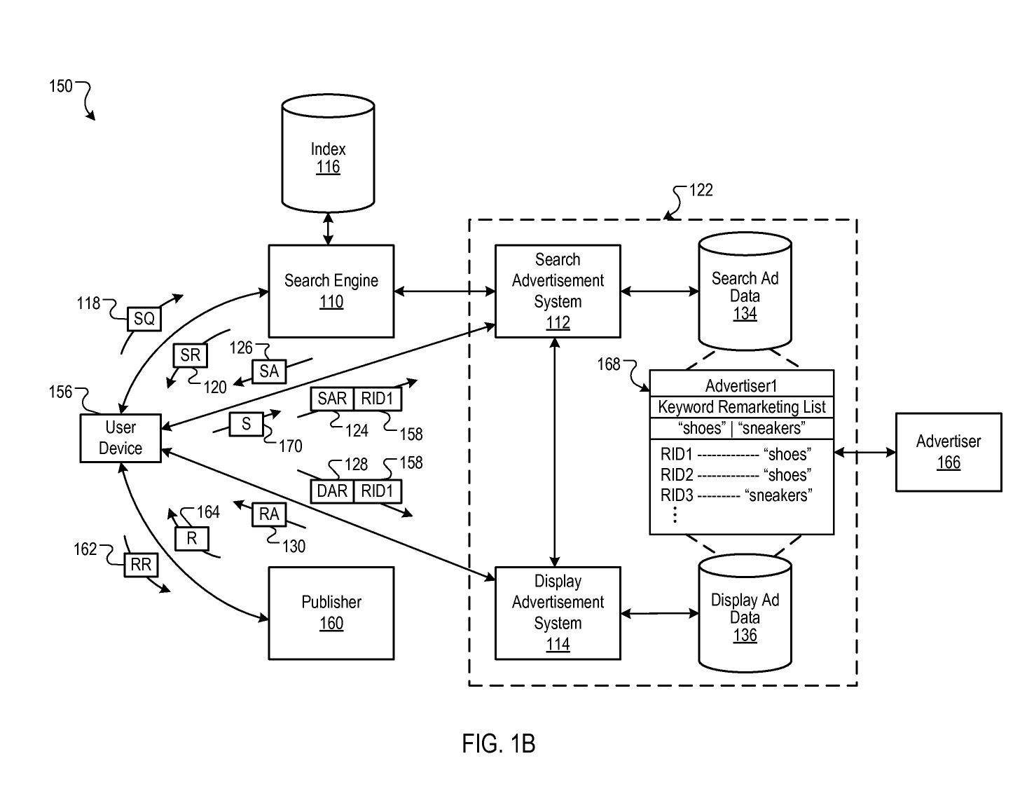

FIG. 1A is a block diagram of an example environment 100 in which keyword remarketing occurs. A computer network 102, such as a local area network (LAN), wide area network (WAN), the Internet, or a combination thereof, connects publisher resources 104, user devices 106, advertisers 108, a search engine 110, a search advertisement system 112, and a display advertisement system 114. The online environment 100 may include many thousands of publisher resources 104 and user devices 106.

FIG. 1B is a block diagram of an example data flow 150 that represents a keyword remarketing process which may be performed in the example environment 100. In particular, the example data flow 150 is a representation of the process by which a remarketing advertisement is provided to a particular user device 156. Reference is made to both FIGS. 1A and 1B in the following description.

A resource 104 is any data that can be provided by a publisher over the network 102 and that is associated with a resource address. Resources include HTML pages, word processing documents, and portable document format (PDF) documents, images, video, and feed sources, to name just a few. The resources may be included in a web site hosted by a publisher, such as publisher 160, and the resources can include content, such as words, phrases, pictures, and so on, and may include embedded information (such as meta information and hyperlinks) and/or embedded instructions (such as scripts).

A user device 106 is an electronic device that is under the control of a user and is capable of requesting and receiving resources 104 over the network 102. Example user devices 106 include personal computers, mobile communication devices, and other devices that can send and receive data over the network 102. A user device 106 typically includes a user application, such as a web browser, to facilitate the sending and receiving of data over the network 102. The web browser can enable a user to display and interact with text, images, videos, music and other information typically located on a web page at a website on the world wide web or a local area network.

To facilitate searching of these resources 104, the search engine 110 identifies the resources by crawling publisher web sites and indexing the resources 104 provided by the publisher web sites. The resources are indexed in an index 116.

The user devices 106 submit search queries to the search engine 110. The search queries are submitted in the form of a search request that includes the search request and, optionally, a unique identifier that identifies the user device 106 that submits the request. The unique identifier can be data from a cookie stored at the user device, or a user account identifier if the user maintains an account with the search engine 110, or some other identifier that identifies the user device 106 or the user using the user device. In the example data flow 150 of FIG. 1B, the user device 156 submits a search query 118, such as the word, “shoes,” to the search engine 110. The search query 118 may be accompanied with an identifier that identifies the user device 156.

In response to the search request, the search engine 110 uses the index 116 to identify resources that are relevant to the queries. The search engine 110 identifies the resources in the form of search results and returns the search results to the user devices 106 in a search results page resource. A search result is data generated by the search engine 110 that identifies a resource that satisfies a particular search query, and includes a resource locator for the resource. An example search result can include a web page title, a snippet of text extracted from the web page, and the URL of the web page.

The search results are ranked based on scores related to the resources identified by the search results, such as information retrieval (“IR”) scores, and optionally a separate ranking of each resource relative to other resources (e.g., an authority score). The search results are ordered according to these scores and provided to the user device according to the order.

For example, the search engine 110 in the example data flow 150 may receive the search query 118, “shoes,” and identify resources related to “shoes” in the index 116. The search engine 110 then provides ranked search results 120 to the user device 156, and each search result includes a resource locator for a resource related to the search query 118, “shoes.”

The user devices 106 receive the search results pages and render the pages for presentation to users. In response to the user selecting a search result at a user device 106, the user device 106 requests the resource identified by the resource locator included in the selected search result. The publisher of the web site hosting the resource receives the request for the resource from the user device 106 and provides the resource to the requesting user device 106.

The search advertisement system 112 and display advertisement system 114 facilitate the provisioning of advertisements with search results and resources 104. The search advertisement system 112 and display advertisement system 114 may be separate systems or, in some implementations, they may be part of a single advertisement management system 122. In particular, the search advertisement system 112 and display advertisement system 114 allow advertisers 108 to define selection rules that take into account attributes of particular users to provide advertisements customized for the users. Example selection rules include keyword based selection, in which advertiser provide bids for keywords that are present in either search queries or webpage content. Advertisements that are associated with keywords having bids that result in an advertisement slot being awarded in response to an auction are selected for displaying in the advertisement slots. Advertisements can be provided for many different resources, such as a search results page resource, or one of the resources 104 hosted by a publisher, e.g., publisher 160.

Another form of advertising facilitated by the advertisement management system 122 is keyword remarketing advertising. Keyword remarketing advertising allows an advertiser 108 to select specific advertisements to be presented to users who have interacted with a keyword advertisement belonging to the advertiser. For example, the advertisement management system 122 may generate a keyword remarketing list associated with the keywords, “shoes” and “sneakers,” which are keywords selected by Advertiser 166. If a user selects one of the Advertiser's advertisements that are served based on the keyword, “shoes” or “sneakers,” that user may be added to a keyword remarketing list and later be provided with a remarketing advertisement based on the previous advertisement selection.

In the example data flow 150, the user device 156 renders the search results page 120 and sends a search advertisement request 124 to the search advertisement system 112, along with one or more keywords related to the search query 118 that the user provided to the search engine 110, e.g., the keyword “shoes.” The search advertisement request 124 may also be accompanied with a recipient identifier 158, e.g., “RID1,” that identifies the user device 156.

The search advertisement system 112, in turn, provides search advertisements 126 to the particular user device 156. For example, Advertiser 166 may have search advertisements that it wants to distribute to users searching for shoes. In the example environment 150, Advertiser 166 has bid for the keyword “shoes” and wins a search advertisement auction, which results in its search advertisement(s) being provided to the user device 156 by the search advertisement system 112.

When a user of a user device 106 selects an advertisement on the search results page, the user device 106 generates a request for a landing page of the advertisement. The landing page may be, for example, a webpage of the advertiser. In some implementations, the advertisers 108 may also be web site publishers, each web site hosting respective web pages, some of which are landing pages for the advertisements of the advertisers 108.

In addition to requesting the landing page of the selected advertisement, the user device 106 may send data indicating that the user has selected the advertisement to the search advertisement system 112 or display advertisement system 114. For example, when the user device 156 selects one of the search advertisements 126, the user device will send selection data 170 to the search advertisement system 112, and the selection data 170 may indicate the particular search advertisement selected by the user and, in some implementations, a recipient identifier for the user device 156. In some implementations, the selection data also includes the particular keyword searched by the user device, e.g., “shoes.”

The search advertisement system 112, upon receipt of the selection data 170 that includes a recipient identifier, may add the recipient identifier to a keyword remarketing list 168 for the advertiser that provided the search advertisement selected by the user device 156. For example, if the selection data 170 indicates that the user selected a search advertisement that was served based on the keyword “shoes,” and the selected search advertisement belonged to advertiser 166, the recipient identifier included in the selection data 170, e.g., “RID1,” can be added to the advertiser's keyword remarketing list 168 for the keyword “shoes.” In some implementations, a keyword included in the selection data, e.g., “shoes,” is also added to the keyword remarketing list and associated with the recipient identifier. The keyword remarketing list 168 may be used by the display advertisement system 114 to provide a remarketing advertisement associated with the keyword remarketing list 168.

In some implementations, if a recipient identifier is already included in a keyword remarketing list, a subsequent search advertisement interaction can be separately recorded in the keyword remarketing list. For example, a new entry in the keyword remarketing list may be created for each search advertisement interaction originating from a particular recipient identifier. In some implementations, a counter may be used to count multiple interactions with a search advertisement based on the same keyword. If a search advertisement is selected based on separate keywords associated with the keyword remarketing list, each keyword may be associated with the recipient identifier in the keyword remarketing list. For example, a user device may be used to select two search advertisements belonging to the advertiser 166 after issuing two different search queries. One search advertisement selection may be a result of the search query “shoes,” while a second selection may be the result of the search query, “sneakers.” In this situation, both keywords, e.g., “sneakers” and “shoes,” may be associated with the corresponding recipient identifier of the user device in the keyword remarketing list 168 for the advertiser 166.

With respect to advertisements provided with a resource 104 from a publisher, the resource includes instructions that cause a user device 106 to send an advertisement request to the display advertisement system 114. The advertisement request may include a recipient identifier for the user device and, optionally, keyword identifiers related to the content of the resource 104. The display advertisement system 114, in turn, provides display advertisements to the particular user device.

For example, the user device 156 may send a resource request 162 to the publisher 160 of a particular resource. The publisher 160 provides the resource 164, e.g., a web page, to the user device 156 along with instructions that cause the user device 156 to send a display advertisement request 128 to the display advertisement system 114. The display advertisement request 128 also includes the recipient identifier 158 for the user device 156. When the display advertisement system 114 receives the display advertisement request 128, it may determine that the recipient identifier 158 included with the request is included in the keyword remarketing list 168. In response to making that determination, the display advertisement system 112 may select an advertisement associated with the keyword remarketing list 168 to provide to the user device 156. If the keyword remarketing list is associated with multiple keywords and advertisements, the particular advertisement selected may depend on the particular keyword used to place the recipient identifier on the keyword remarketing list. If the display advertising system determines that a recipient identifier is not included in a keyword remarketing list, it may use any suitable method to provide a standard display advertisement.

In some implementations, the display advertisement system 114, in response to each request for display advertisements, conducts an auction to select display advertisements that are provided in response to the request. The display advertisements may include remarketing advertisements, among other advertisements, each of which may be ranked according to a score that is based on an advertisement bid and one or more parameters specified in the display ad data 136. The highest ranked display advertisements resulting from the auction are selected and provided to the requesting user device.

The advertisement management system 122 includes a data storage system that stores search ad data 132 and display ad data 134. The each data storage stores advertisements, selection information, and budgeting information for advertisers. In some implementations, the data stores also performance data indicating the performance of the advertisements that are served. Such performance data can include, for example, click through rates for advertisements, the number of impressions for advertisements, and the number of conversions for advertisements. Other performance data can also be stored.

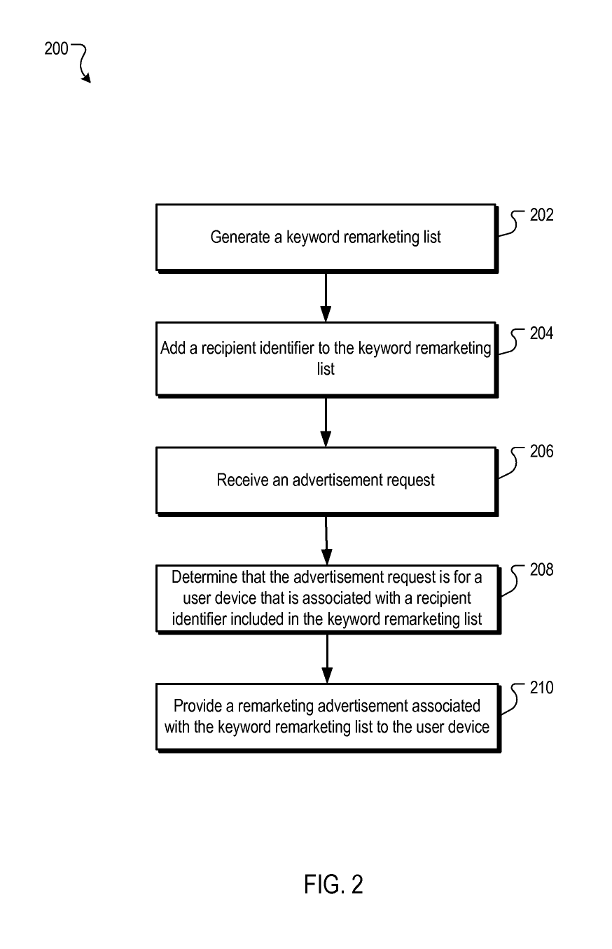

FIG. 2 is a flow diagram of an example process 200 for performing keyword remarketing. The process 200 may be used by a data processing apparatus that is used to realize one or more of the systems described above. In particular, the process 200 may be used by a display advertisement system or advertisement management system to provide a remarketing advertisement to a user device.

The process 200 generates a keyword remarketing list (202). The keyword remarketing list is associated with one or more keywords selected by an advertiser. In some implementations, the advertiser selects keywords that are being used to serve the advertiser's search advertisements. For example, if an advertiser is an online bicycle retailer using the keywords “mountain bike,” “mountain bike sale,” “road bike,” and “road bike sale” to serve its search advertisements, then keywords “mountain bike,” and “road bike” may be selected by the advertiser for associating with a keyword remarketing list. Any single keyword or combinations of keywords being used by the advertiser for search advertisements may be selected for associating with a keyword remarketing list.

The process 200 adds a recipient identifier to the keyword remarketing list (204). The recipient identifier is added to the keyword remarketing list in response to receiving an indication that a user device that corresponds to the recipient identifier has interacted with a search advertisement of the advertiser, and the search advertisement was provided to the user device in response to the user device transmitting a search query associated with one of the keywords. This may be done for each recipient identifier corresponding to a user device that has interacted with a search advertisement.

In some implementations, the interaction with the search advertisement is a selection of the search advertisement at the user device. For example, if a user device transmits a search query including the keyword “mountain bike,” the user device may be provided with one of the bicycle retailer's advertisements associated with the keyword “mountain bike.” Upon receiving an indication that the advertisement was selected, the process 200 may add a recipient identifier of the user device to the bicycle retailer's keyword remarketing list for the “mountain bike” keyword. In some implementations, the particular keyword, e.g., “mountain bike,” is also stored with the recipient identifier in the keyword remarketing list. In some implementations, the recipient identifier is stored in a cookie associated with an advertisement server, and the cookie including the identifier is provided to the user device in response to the advertisement selection.

The process 200 receives an advertisement request (206). The advertisement request may be for an advertisement that is to be provided with a publisher resource. In some implementations, the publisher resource is a web page hosted by a publisher, and the advertisement request is generated in response to the user device rendering the publisher resource. For example, a user device may request a web page from the publisher of a sports news website. When the user device renders the web page provided by the publisher, the user device may also request an advertisement to fill an ad slot of the requested web page.

In some implementations, the advertisement request is received from the user device that is associated with a recipient identifier included in the keyword remarketing list. For example, the same user device that clicked on the search advertisement associated with the keyword, “mountain bike,” may be the same user device requesting the advertisement. In some implementations, the advertisement request is received from an advertisement network, and the advertisement request includes data indicating that the advertisement request is for a user device that is associated with a recipient identifier included in the keyword remarketing list. For example, the same user device that clicked on the search advertisement associated with the keyword, “mountain bike,” may have requested an advertisement from an advertisement network, which in turn provided the advertisement request and recipient identifier to a data processing apparatus implementing the process 200.

The process 200 determines that the advertisement request is for a user device that is associated with a recipient identifier that is included in the keyword remarketing list (208). For example, the recipient identifier included in the advertisement request may match a recipient identifier included in the keyword remarketing list, e.g., the recipient identifier that was added to the keyword remarketing list in response to its corresponding user device selecting the search advertisement that was served based on the keyword “mountain bike.”

In response to the determination, the process 200 provides a remarketing advertisement associated with the keyword remarketing list to the user device (210). The remarketing advertisement is an advertisement provided by an advertiser for distribution to user devices associated with recipient identifiers included in one of its keyword remarketing lists. For example, the bicycle retailer may create two advertisements, one advertisement for a mountain bike that it sells online, and a second advertisement for a road bike that it sells online. The retailer may associate the advertisements with its keyword remarketing list for the keywords “mountain bike,” and “road bike.” When a user device with a recipient identifier included in the list requests an advertisement, the user device may be provided with one of the advertisements that the retailer associated with the list.

In some implementations the particular advertisement provided may depend on the keyword associated with the recipient identifier included in the list. For example, if the recipient identifier was added to the list based on the keyword “mountain bike,” the advertisement for the mountain bike may be provided to the user device. Conversely, if the recipient identifier was added to the list based on the keyword “road bike,” the advertisement for the road bike may be provided to the user device.

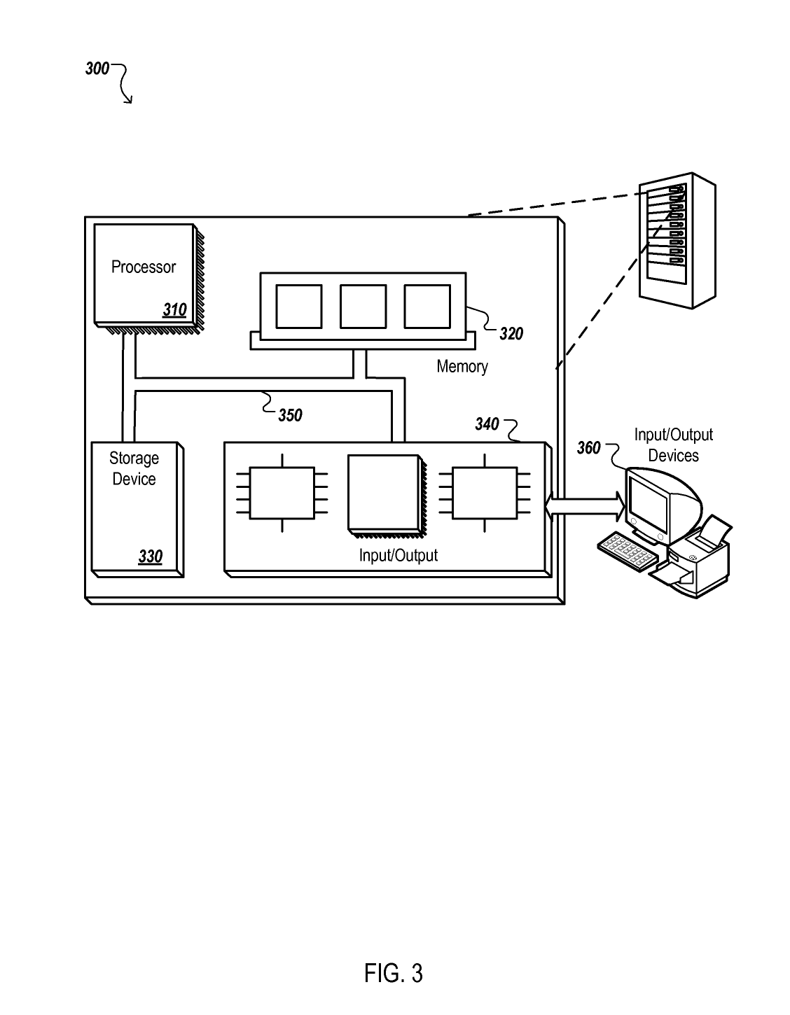

FIG. 3 is a block diagram of an example data processing apparatus 300 that can be used to perform operations described above. The apparatus 300 includes a processor 310, a memory 320, a storage device 330, and an input/output device 340. Each of the components 310, 320, 330, and 340 can be interconnected, for example, using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330.

The memory 320 stores information within the apparatus 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the apparatus 300. In one implementation, the storage device 330 is a computer-readable medium. In various different implementations, the storage device 330 can include, for example, a hard disk device, an optical disk device, a storage device that is shared over a network by multiple computing devices, e.g., a cloud storage device, or some other large capacity storage device.

The input/output device 340 provides input/output operations for the apparatus 300. In one implementation, the input/output device 340 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 360. Other implementations, however, can also be used, such as mobile computing devices, mobile communication devices, set-top box television client devices, etc.

Although an example data processing apparatus has been described in FIG. 3, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving, from a content item provider, a request to create a keyword remarketing list that includes recipient identifiers corresponding to user devices that interacted with search content items that were provided by the content item provider and were presented with search results that were provided to the user device in response to a search query matching a keyword specified by the content item provider;
including, by one or more data processing apparatus and in the keyword remarketing list and in response to the request, a recipient identifier of a user device at which a user interaction with a search content item of the content item provider occurred when the search content item was presented with search results provided to the user device in response to submission, by the user device, of a search query matching the keyword;
receiving a content item request for a content item to be provided with a publisher resource;
determining, based on the content item request and by one or more data processing apparatus, that a content item provided in response to the content item request will be provided to the user device corresponding to the recipient identifier that is included in the keyword remarketing list; and
in response to the determination, identifying, by one or more data processing apparatus, a remarketing content item that the content item provider has designated for distribution to user devices corresponding to recipient identifiers that are included in the keyword remarketing list; and
providing, in response to the content item request, the identified remarketing content item for presentation with the publisher resource.

2. (canceled)

3. The method of claim 1, wherein receiving a content item request comprises receiving a content item request from a content item network, and the content item request includes data indicating that the content item request is for a user device that is associated with a recipient identifier included in the keyword remarketing list.

4. The method of claim 1, wherein the publisher resource is a web page hosted by a publisher, and wherein the content item request is generated in response to the user device rendering the publisher resource.

5. The method of claim 1, wherein the interaction with the search content item comprises a selection of the search content item at the user device.

6. The method of claim 5, wherein the recipient identifier is stored in a cookie associated with a content item server, and the cookie is provided to the user device in response to the selection.

7. A system comprising:
a data store storing executable instructions; and
one or more data processing apparatus that interact with the data store and upon execution of the instructions perform operations comprising:
receiving, from a content item provider, a request to create a keyword remarketing list that includes recipient identifiers corresponding to user devices that interacted with search content items that were provided by the content item provider and were presented with search results that were provided to the user device in response to a search query matching a keyword specified by the content item provider;
including, in the keyword remarketing list and in response to the request, a recipient identifier of a user device at which a user interaction with a search content item of the content item provider occurred when the search content item was presented with search results provided to the user device in response to submission, by the user device, of a search query matching the keyword;
receiving a content item request for a content item to be provided with a publisher resource;
determining, based on the content item request, that a content item provided in response to the content item request will be provided to the user device corresponding to the recipient identifier that is included in the keyword remarketing list; and
in response to the determination, identifying a remarketing content item that the content item provider has designated for distribution to user devices corresponding to recipient identifiers that are included in the keyword remarketing list; and
providing, in response to the content item request, the identified remarketing content item for presentation with the publisher resource.

8. (canceled)

9. The system of claim 7, wherein receiving a content item request comprises receiving a content item request from a content item network, and the content item request includes data indicating that the content item request is for a user device that is associated with a recipient identifier included in the keyword remarketing list.

10. The system of claim 7, wherein the publisher resource is a web page hosted by a publisher, and wherein the content item request is generated in response to the user device rendering the publisher resource.

11. The system of claim 7, wherein the interaction with the search content item comprises a selection of the search content item at the user device.

12. The system of claim 11, wherein the recipient identifier is stored in a cookie associated with a content item server, and the cookie is provided to the user device in response to the selection.

13. A non-transitory computer readable medium comprising instructions that, when executed by a data processing apparatus, perform operations comprising:
receiving, from a content item provider, a request to create a keyword remarketing list that includes recipient identifiers corresponding to user devices that interacted with search content items that were provided by the content item provider and were presented with search results that were provided to the user device in response to a search query matching a keyword specified by the content item provider;
including, in the keyword remarketing list and in response to the request, a recipient identifier of a user device at which a user interaction with a search content item of the content item provider occurred when the search content item was presented with search results provided to the user device in response to submission, by the user device, of a search query matching the keyword;
receiving a content item request for a content item to be provided with a publisher resource;
determining, based on the content item request, that a content item provided in response to the content item request will be provided to the user device corresponding to the recipient identifier that is included in the keyword remarketing list; and
in response to the determination, identifying a remarketing content item that the content item provider has designated for distribution to user devices corresponding to recipient identifiers that are included in the keyword remarketing list; and
providing, in response to the content item request, the identified remarketing content item for presentation with the publisher resource.

14. (canceled)

15. The computer readable medium of claim 13, wherein receiving a content item request comprises receiving a content item request from a content item network, and the content item request includes data indicating that the content item request is for a user device that is associated with a recipient identifier included in the keyword remarketing list.

16. The computer readable medium of claim 13, wherein the publisher resource is a web page hosted by a publisher, and wherein the content item request is generated in response to the user device rendering the publisher resource.

17. The computer readable medium of claim 13, wherein the interaction with the search content item comprises a selection of the search content item at the user device.

18. The computer readable medium of claim 17, wherein the recipient identifier is stored in a cookie associated with a content item server, and the cookie is provided to the user device in response to the selection.
